(19) United States
(12) Patent Application Publication
(10) Pub. No.: US 2019/0177474 A1
(43) Pub. Date: Jun. 13, 2019

(54) AMORPHOUS THERMOPLASTIC POLYESTER FOR THE PRODUCTION OF HOLLOW ARTICLES

(71) Applicant: ROQUETTE FRERES, Lestrem (FR)

(72) Inventors: Hélène AMEDRO, BETHUNE (FR); René SAINT-LOUP, LOMME (FR)

(21) Appl. No.: 16/308,090

(22) PCT Filed: Jun. 9, 2017
(86) PCT No.: PCT/FR2017/051472

§ 371 Date: Dec. 7, 2018

(30) Foreign Application Priority Data
Jun. 10, 2016 (FR) 16 55351

(51) Int. Cl. C08G 63/672; B29D 22/00

(52) U.S. Cl. CPC C08G 63/672; B29K 2067/003; B29D 22/003

(57) ABSTRACT

The invention relates to the use of an amorphous thermoplastic polyester for the production of hollow articles, said amorphous thermoplastic polyester comprising at least one 1,4:3,6-dianhydrohexitol unit (A), at least one alicyclic diol unit (B) other than 1,4:3,6-dianhydrohexitol units (A), at least one terephthalic acid unit (C), the molar ratio (A)/[(A)+(B)] being at least 0.32 and at most 0.90 and said polyester being free of non-cyclic aliphatic diol units or comprising a molar amount of non-cyclic aliphatic diol units, relative to the total monomer units of the polyester, that is less than 5%, and having a reduced solution viscosity (25° C.; phenol (50% m) : ortho-dichlorobenzene (50% m); 5 g/L polyester) that is greater than 50 mL/g.

### FIELD OF THE INVENTION

The present invention relates to the use of an amorphous thermoplastic polyester comprising at least one 1,4:3,6-dianhydrohexitol unit for the production of hollow articles.

### TECHNICAL BACKGROUND OF THE INVENTION

Plastics have become essential to the mass production of objects. Indeed, their thermoplastic character enables these materials to be transformed at a high rate into all kinds of objects.

Certain thermoplastic aromatic polyesters have thermal properties which allow them to be used directly for the production of materials. They comprise aliphatic diol and aromatic diacid units. Among these aromatic polyesters, mention may be made of polyethylene terephthalate (PET), which is a polyester comprising ethylene glycol and terephthalic acid units, used for example in the production of films.

However, for certain applications or under certain usage conditions, it is necessary to improve certain properties, especially impact strength or else heat resistance. This is why glycol-modified PETs (PETgs) have been developed. They are generally polyesters comprising, in addition to the ethylene glycol and terephthalic acid units, cyclohexanedimethanol (CHDM) units. The introduction of this diol into the PET enables it to adapt the properties to the intended application, for example to improve its impact strength or its optical properties, especially when the PETg is amorphous.

Other modified PETs have also been developed by introducing, into the polyester, 1,4:3,6-dianhydrohexitol units, especially isosorbide (PEIT). These modified polyesters have higher glass transition temperatures than unmodified PETs or PETgs comprising CHDM. In addition, 1,4:3,6-dianhydrohexitols have the advantage of being able to be obtained from renewable resources such as starch.

One problem with these PEITs is that they may have insufficient impact strength properties. In addition, the glass transition temperature may be insufficient for the production of certain plastic objects.

In order to improve the impact strength properties of the polyesters, it is known from the prior art to use polyesters in which the crystallinity has been reduced. As regards isosorbide-based polyesters, mention may be made of application US2012/0177854, which describes polyesters comprising terephthalic acid units and diol units comprising from 1 to 60 mol % of isosorbide and from 5 to 99% of 1,4-cyclohexanedimethanol which have improved impact strength properties. As indicated in the introductory section of this application, the aim is to obtain polymers in which the crystallinity is eliminated by the addition of comonomers, and hence in this case by the addition of 1,4-cyclohexanedimethanol. In the examples section, the production of various poly(ethylene-co-1,4-cyclohexanedimethylene-co-isosorbide)terephthalates (PECITs), and also an example of poly(1,4-cyclohexanedimethylene-co-isosorbide)terephthalate (PCIT), are described.

It may also be noted that while polymers of PECIT type have been the subject of commercial developments, this is not the case for PCITs. Indeed, their production was hitherto considered to be complex, since isosorbide has low reactivity as a secondary diol. Yoon et al. (Synthesis and Characteristics of a Biobased High-Tg Terpolyester of Isosorbide, Ethylene Glycol, and 1,4-Cyclohexane Dimethanol: Effect of Ethylene Glycol as a Chain Linker on Polymerization, Macromolecules, 2013, 46, 7219-7231) thus showed that the synthesis of PCIT is much more difficult to achieve than that of PECIT. This paper describes the study of the influence of the ethylene glycol content on the PECIT production kinetics.

In Yoon et al., an amorphous PCIT (which comprises approximately 29% isosorbide and 71% CHDM, relative to the sum of the diols) is produced to compare its synthesis and its properties with those of PECIT-type polymers. The use of high temperatures during the synthesis induces thermal degradation of the polymer formed if reference is made to the first paragraph of the Synthesis section on page 7222, this degradation especially being linked to the presence of aliphatic cyclic diols such as isosorbide. Therefore, Yoon et al. used a process in which the polycondensation temperature is limited to 270° C. Yoon et al. observed that, even increasing the polymerization time, the process also does not make it possible to obtain a polyester having a sufficient viscosity. Thus, without addition of ethylene glycol, the viscosity of the polyester remains limited, despite the use of prolonged synthesis times.

Thus, despite the modifications made to the PETs, there is still an ongoing need for novel polyesters having improved properties.

In the field of plastic materials, and especially for the production of hollow articles, it is necessary to have an amorphous thermoplastic polyester with improved properties, especially having a high reduced viscosity in solution, which ultimately make it possible to produce bottles having good stability to chemical products.

Objects produced from polymers having terephthalic acid units, ethylene glycol units and isosorbide units and optionally another diol (for example 1,4-cyclohexanedimethanol) are known from document U.S. Pat. No. 6,126,992. All the polymers obtained thus have ethylene glycol units, since it is widely accepted that they are necessary for the incorporation of the isosorbide and to obtaining a high glass transition temperature. Moreover, the examples of preparation implemented do not make it possible to obtain polymers having high glass transition temperatures; on the contrary, they are even too low (106° C. for the polymer of example 1 and 116° C. for the polymer of example 2) to be entirely satisfactory in the production of hollow articles.

Document U.S. Pat. No. 6,063,465 describes polyester containers produced from a polymer having isosorbide units, terephthalic acid units and ethylene glycol units. The containers thus produced are suitable for containing both liquids and solids. Examples 1 and 2 present the synthesis of polyester based on dimethyl terephthalate, isosorbide and ethylene glycol. The polymer obtained according to example 2 is prepared in the same way as that of example 1 but has a higher isosorbide content.

Thus, there is currently still a need for thermoplastic polyesters containing 1,4:3,6-dianhydrohexitol units for the production of hollow articles, said polyesters thus having improved mechanical properties, being readily formable and having good stability to chemical products.

It is thus to the applicant's credit to have found that this object could be achieved with an amorphous thermoplastic polyester based on isosorbide and without ethylene glycol, while it was hitherto known that the latter was essential for the incorporation of said isosorbide. Indeed, by virtue of a particular viscosity and ratio of units, the amorphous thermoplastic polyester used according to the present invention has improved properties for a use according to the invention in the production of hollow articles and especially bottles.

### SUMMARY OF THE INVENTION

Thus, a subject of the invention is the use of an amorphous thermoplastic polyester for the production of hollow articles, said amorphous thermoplastic polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
   the (A)/[(A)+(B)] molar ratio being at least 0.32 and at most 0.90 and the reduced viscosity in solution being greater than 50 ml/g,
   said polyester not containing any aliphatic non-cyclic diol units or comprising a molar amount of aliphatic non-cyclic diol units, relative to all the monomer units of the polyester, of less than 5%, the reduced viscosity in solution (25° C.; phenol (50% m): ortho-dichlorobenzene (50% m); 5 g of polyester/I) of said polyester being greater than 75 ml/g.

These polyesters have improved thermal and mechanical properties and especially good heat resistance, due to a high glass transition temperature, which is particularly beneficial for the production of hollow articles.

### DETAILED DESCRIPTION OF THE INVENTION

A first subject of the invention relates to the use of an amorphous thermoplastic polyester for the production of hollow articles, said amorphous thermoplastic polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
   the (A)/[(A)+(B)] molar ratio being at least 0.32 and at most 0.90 and the reduced viscosity in solution being greater than 50 ml/g.

(A)/[(A)+(B)] molar ratio is intended to mean the molar ratio of 1,4:3,6-dianhydrohexitol units (A)/sum of 1,4:3,6-dianhydrohexitol units (A) and alicyclic diol units (B) other than 1,4:3,6-dianhydrohexitol units (A).

The amorphous thermoplastic polyester does not contain any aliphatic non-cyclic diol units, or comprises a small amount thereof.

“Small molar amount of aliphatic non-cyclic diol units” is intended to mean, especially, a molar amount of aliphatic non-cyclic diol units of less than 5%. According to the invention, this molar amount represents the ratio of the sum of the aliphatic non-cyclic diol units, these units possibly being identical or different, relative to all the monomer units of the polyester.

An aliphatic non-cyclic diol may be a linear or branched aliphatic non-cyclic diol. It may also be a saturated or unsaturated aliphatic non-cyclic diol. Aside from ethylene glycol, the saturated linear aliphatic non-cyclic diol may for example be 1,3-propanediol, 1,4-butanediol, 1,5-pentanediol, 1,6-hexanediol, 1,8-octanediol and/or 1,10-decanediol. As examples of saturated branched aliphatic non-cyclic diol, mention may be made of 2-methyl-1,3-propanediol, 2,2,4-trimethyl-1,3-pentanediol, 2-ethyl-2-butyl-1,3-propanediol, propylene glycol and/or neopentyl glycol. As an example of an unsaturated aliphatic diol, mention may be made, for example, of cis-2-butene-1,4-diol.

This molar amount of aliphatic non-cyclic diol units is advantageously less than 1%. Preferably, the polyester does not contain any aliphatic non-cyclic diol units and more preferentially it does not contain ethylene glycol.

Despite the small amount of aliphatic non-cyclic diol, and hence of ethylene glycol, used for the synthesis, an amorphous thermoplastic polyester is surprisingly obtained which has a high reduced viscosity in solution and in which the isosorbide is particularly well incorporated. Without being bound by any one theory, this would be explained by the fact that the reaction kinetics of ethylene glycol are much faster than those of 1,4:3,6-dianhydrohexitol, which greatly limits the integration of the latter into the polyester. The polyesters resulting therefrom thus have a low degree of integration of 1,4:3,6-dianhydrohexitol and consequently a relatively low glass transition temperature.

The monomer (A) is a 1,4:3,6-dianhydrohexitol (A) and may be isosorbide, isomannide, isoidide, or a mixture thereof. Preferably, the 1,4:3,6-dianhydrohexitol (A) is isosorbide.

Isosorbide, isomannide and isoidide may be obtained, respectively, by dehydration of sorbitol, of mannitol and of iditol. As regards isosorbide, it is sold by the applicant under the brand name Polysorb® P.

The alicyclic diol (B) is also referred to as aliphatic and cyclic diol. It is a diol which may especially be chosen from 1,4-cyclohexanedimethanol, 1,2-cyclohexanedimethanol, 1,3-cyclohexanedimethanol or a mixture of these diols. Preferentially, the alicyclic diol (B) is 1,4-cyclohexanedimethanol.

The alicyclic diol (B) may be in the cis configuration, in the trans configuration, or may be a mixture of diols in the cis and trans configurations.

The molar ratio of 1,4:3,6-dianhydrohexitol units (A)/sum of 1,4:3,6-dianhydrohexitol units (A) and alicyclic diol units (B) other than 1,4:3,6-dianhydrohexitol units (A) is at least 0.32 and at most 0.90.

An amorphous thermoplastic polyester that is particularly suitable for the production of hollow articles comprises:
a molar amount of 1,4:3,6-dianhydrohexitol units (A) ranging from 16 to 54%;
a molar amount of alicyclic diol units (B) other than the 1,4:3,6-dianhydrohexitol units (A) ranging from 5 to 30%;
a molar amount of terephthalic acid units (C) ranging from 45 to 55%.

The amounts of different units in the polyester may be determined by 1H NMR or by chromatographic analysis of the mixture of monomers resulting from complete hydrolysis or methanolysis of the polyester, preferably by 1H NMR.

Those skilled in the art can readily find the analysis conditions for determining the amounts of each of the units of the polyester. For example, from an NMR spectrum of a poly(1,4-cyclohexanedimethylene-co-isosorbide terephthalate), the chemical shifts relating to the 1,4-cyclohexanedimethanol are between 0.9 and 2.4 ppm and 4.0 and 4.5 ppm, the chemical shifts relating to the terephthalate ring are between 7.8 and 8.4 ppm and the chemical shifts relating to the isosorbide are between 4.1 and 5.8 ppm. The integration of each signal makes it possible to determine the amount of each unit of the polyester.

The amorphous thermoplastic polyesters used according to the invention have a glass transition temperature ranging from 115 to 200° C., for example from 140 to 190° C. The glass transition temperature is measured by conventional methods and especially a differential scanning calorimetry (DSC) method using a heating rate of 10° C./min. The experimental protocol is described in detail in the examples section below.

The amorphous thermoplastic polyester especially has a lightness L* greater than 40. Advantageously, the lightness L* is greater than 55, preferably greater than 60, most preferentially greater than 65, for example greater than 70. The parameter L* may be determined using a spectrophotometer, using the CIE Lab model.

Finally, the reduced viscosity in solution is greater than 50 ml/g and less than 120 ml/g, this viscosity being able to be measured using an Ubbelohde capillary viscometer at 25° C. in an equi-mass mixture of phenol and ortho-dichlorobenzene after dissolving the polymer at 130° C. with stirring, the concentration of polymer introduced being 5 g/l.

This test for measuring reduced viscosity in solution is, due to the choice of solvents and the concentration of the polymers used, perfectly suited to determining the viscosity of the viscous polymer prepared according to the process described below.

The amorphous character of the thermoplastic polyesters used according to the present invention is characterized by the absence of X-ray diffraction lines and also by the absence of an endothermic fusion peak in differential scanning calorimetry (DSC).

The amorphous thermoplastic polyester as defined above does indeed have advantages for the production of hollow articles.

Indeed, by virtue especially of the molar ratio of 1,4:3,6-dianhydrohexitol units (A)/sum of 1,4:3,6-dianhydrohexitol units (A) and alicyclic diol units (B) other than the 1,4:3,6-dianhydrohexitol units (A), the amorphous thermoplastic polyesters have better heat resistance, which enables the hollow articles produced therefrom to have good stability to chemical products.

For the purposes of the present invention, a chemical product may for example be an alcohol such as ethanol, methanol, isopropanol or the mixture thereof, a ketone such as acetone, methylethyl ketone or the mixture thereof, an aliphatic hydrocarbon such as, for example, toluene or xylene, an aromatic hydrocarbon such as, for example, cyclohexane or heptane, petrol or else a terpene such as, for example, limonene.

The chemical product may be an ordinary chemical product such as, for example, a detergent, laundry product, polish or else dishwashing product. Finally, the chemical product may also be a cosmetic product such as, for example, a makeup remover, foundation, sun cream or else a perfume.

For the purposes of the present invention, a hollow article is a hollow article essentially consisting of plastic and may for example be a bottle, a flask, a can, a barrel or a tank. The hollow article is preferably a bottle.

The hollow article may be produced by techniques known to those skilled in the art such as, for example, extrusion blow-molding or injection molding. Production is preferably carried out by extrusion blow-molding. According to this method, a parison is continuously formed with the amorphous thermoplastic polyester before being clamped in a mold then blown in order to adopt the desired form.

The form and the volume of the hollow article depend on the features of the mold used for the blow-molding. Regarding the volume, it may vary from a few cm³ to a few m³, especially from 20 cm³ to 0.1 m³ and preferably from 100 cm³ to 5000 cm³, and even more particularly from 500 cm³ to 2000 cm³, such as, for example, 1500 cm³.

The amorphous thermoplastic polyester may be packaged in a manipulable form such as pellets or granules before being used for the production of hollow articles. Thus, for example, for production according to the technique of extrusion blow-molding, the amorphous thermoplastic polymer is introduced in the form of granules.

According to a particular embodiment, and regardless of the method used for producing the hollow article, the amorphous thermoplastic polyester defined above may be used in combination with an additional polymer.

The additional polymer may be chosen from polyamides, polyesters other than the polyester according to the invention, polystyrene, styrene copolymers, styrene-acrylonitrile copolymers, styrene-acrylonitrile-butadiene copolymers, poly(methyl methacrylate)s, acrylic copolymers, poly(ether-imide)s, poly(phenylene oxide)s, such as poly(2,6-dimethylphenylene oxide), poly(phenylene sulfate)s, poly(ester-carbonate)s, polycarbonates, polysulfones, polysulfone ethers, polyether ketones, and mixtures of these polymers.

The additional polymer may also be a polymer which makes it possible to improve the impact properties of the polymer, especially functional polyolefins such as functionalized ethylene or propylene polymers and copolymers, core-shell copolymers or block copolymers.

During the production of the hollow article from the amorphous thermoplastic polyester, one or more additives may also be added in order to give the finished product particular properties.

Thus, the additive may for example be an antioxidant such as a sterically hindered phenol or a phosphonate, or else may be a dye.

The use in the present invention of amorphous thermoplastic polymers as defined above for the production of hollow articles is particularly advantageous because it makes it possible to obtain hollow articles having good stability to chemical products.

A second subject of the invention relates to hollow articles comprising the amorphous thermoplastic polyester described above. The hollow articles may also comprise an additional polymer and/or one or more additives as defined above.

The amorphous thermoplastic polyester that is particularly suited to the production of hollow articles may be prepared by a production process comprising:
a step of introducing, into a reactor, monomers comprising at least one 1,4:3,6-dianhydrohexitol (A), at least one alicyclic diol (B) other than the 1,4:3,6-dianhydrohexitols (A) and at least one terephthalic acid (C), the molar ratio ((A)+(B))/(C) ranging from 1.05 to 1.5, said monomers not containing any aliphatic non-cyclic diols or comprising, relative to all of the monomers introduced, a molar amount of aliphatic non-cyclic diol units of less than 5%;
a step of introducing, into the reactor, a catalytic system;
a step of polymerizing said monomers to form the polyester, said step consisting of:
   a first stage of oligomerization, during which the reaction medium is stirred under an inert atmosphere at a temperature ranging from 265 to 280° C., advantageously from 270 to 280° C., for example 275° C.;
   a second stage of condensation of the oligomers, during which the oligomers formed are stirred under vacuum at a temperature ranging from 278 to 300° C. so as to form the polyester, advantageously from 280 to 290° C., for example 285° C.;
a step of recovering the amorphous thermoplastic polyester.

This first stage of the process is carried out in an inert atmosphere, that is to say under an atmosphere of at least one inert gas. This inert gas may especially be dinitrogen. This first stage may be carried out under a gas stream and it may also be carried out under pressure, for example at a pressure of between 1.05 and 8 bar.

Preferably, the pressure ranges from 3 to 8 bar, most preferentially from 5 to 7.5 bar, for example 6.6 bar. Under these preferred pressure conditions, the reaction of all the monomers with one another is promoted by limiting the loss of monomers during this stage.

Prior to the first stage of oligomerization, a step of deoxygenation of the monomers is preferentially carried out. It can be carried out for example once the monomers have been introduced into the reactor, by creating a vacuum then by introducing an inert gas such as nitrogen thereto. This vacuum-inert gas introduction cycle can be repeated several times, for example from 3 to 5 times. Preferably, this vacuum-nitrogen cycle is carried out at a temperature of between 60 and 80° C. so that the reagents, and especially the diols, are totally molten. This deoxygenation step has the advantage of improving the coloration properties of the polyester obtained at the end of the process.

The second stage of condensation of the oligomers is carried out under vacuum. The pressure may decrease continuously during this second stage by using pressure decrease ramps, in steps, or else using a combination of pressure decrease ramps and steps. Preferably, at the end of this second stage, the pressure is less than 10 mbar, most preferentially less than 1 mbar.

The first stage of the polymerization step preferably has a duration ranging from 20 minutes to 5 hours. Advantageously, the second stage has a duration ranging from 30 minutes to 6 hours, the beginning of this stage consisting of the moment at which the reactor is placed under vacuum, that is to say at a pressure of less than 1 bar.

The process also comprises a step of introducing a catalytic system into the reactor. This step may take place beforehand or during the polymerization step described above.

Catalytic system is intended to mean a catalyst or a mixture of catalysts, optionally dispersed or fixed on an inert support.

The catalyst is used in amounts suitable for obtaining a high-viscosity polymer in accordance with the use according to the invention for the production of hollow articles.

An esterification catalyst is advantageously used during the oligomerization stage. This esterification catalyst can be chosen from derivatives of tin, titanium, zirconium, hafnium, zinc, manganese, calcium and strontium, organic catalysts such as para-toluenesulfonic acid (PTSA) or methanesulfonic acid (MSA), or a mixture of these catalysts. By way of examples of such compounds, mention may be made those given in application US 2011/282020 A1 in paragraphs [0026] to [0029], and on page 5 of application WO 2013/062408 A1.

Preferably, a zinc derivative or a manganese, tin or germanium derivative is used during the first stage of transesterification. By way of example of amounts by weight, use may be made of from 10 to 500 ppm of metal contained in the catalytic system during the oligomerization stage, relative to the amount of monomers introduced.

At the end of transesterification, the catalyst from the first step can be optionally blocked by adding phosphorous acid or phosphoric acid, or else, as in the case of tin(IV), reduced with phosphites such as triphenyl phosphite or tris(nonylphenyl) phosphites or those cited in paragraph [0034] of application US 2011/282020 A1.

The second stage of condensation of the oligomers may optionally be carried out with the addition of a catalyst. This catalyst is advantageously chosen from tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may for example be those given in patent EP 1 882 712 B1 in paragraphs [0090] to [0094].

Preferably, the catalyst is a tin, titanium, germanium, aluminum or antimony derivative.

By way of example of amounts by weight, use may be made of from 10 to 500 ppm of metal contained in the catalytic system during the stage of condensation of the oligomers, relative to the amount of monomers introduced.

Preferably, a catalytic system is used during the first stage and the second stage of polymerization. Said system advantageously consists of a catalyst based on tin or of a mixture of catalysts based on tin, titanium, germanium and aluminum.

By way of example, use may be made of an amount by weight of 10 to 500 ppm of metal contained in the catalytic system, relative to the amount of monomers introduced.

According to the preparation process, an antioxidant is advantageously used during the step of polymerization of the monomers. These antioxidants make it possible to reduce the coloration of the polyester obtained. The antioxidants may be primary and/or secondary antioxidants. The primary antioxidant may be a sterically hindered phenol, such as the compounds Hostanox® 0 3, Hostanox® 0 10, Hostanox® 0 16, Ultranox® 210, Ultranox® 276, Dovernox® 10, Dovernox® 76, Dovernox® 3114, Irganox® 1010 or Irganox® 1076 or a phosphonate such as Irgamod® 195. The secondary antioxidant may be trivalent phosphorus compounds such as Ultranox® 626, Doverphos® S-9228, Hostanox® P-EPQ or Irgafos 168.

It is also possible to introduce as polymerization additive into the reactor at least one compound that is capable of limiting unwanted etherification reactions, such as sodium acetate, tetramethylammonium hydroxide or tetraethylammonium hydroxide.

The process also comprises a step of recovering the polyester at the end of the polymerization step. The amorphous thermoplastic polyester thus recovered is then formed as described above.

The invention will be better understood using the following examples and figure.

### EXAMPLE

The properties of the polymers were studied using the following techniques:

Reduced Viscosity in Solution

The reduced viscosity in solution is evaluated using an Ubbelohde capillary viscometer at 25° C. in an equi-mass mixture of phenol and ortho-dichlorobenzene after dissolving the polymer at 130° C. with stirring, the concentration of the polymer introduced being 5 g/l.

DSC

The thermal properties of the polyesters were measured by differential scanning calorimetry (DSC): the sample is first heated under a nitrogen atmosphere in an open crucible from 10° C. to 320° C. (10° C.min⁻¹), cooled to 10° C. (10° C.min⁻¹), then heated again to 320° C. under the same conditions as the first step. The glass transition temperatures were taken at the mid-point of the second heating. Any melting points are determined on the endothermic peak (onset) at the first heating. Similarly, the enthalpy of fusion (area under the curve) is determined at the first heating.

For the illustrative examples presented below, the following reagents were used:

1,4-Cyclohexanedimethanol (99% purity, mixture of cis and trans isomers)
Isosorbide (purity >99.5%) Polysorb® P from Roquette Fréres
Terephthalic acid (99+% purity) from Acros
Irganox® 1010 from BASF AG
Dibutyltin oxide (98% purity) from Sigma-Aldrich

### Preparation of the Amorphous Thermoplastic Polyester and Use for the Production of Bottles by Extrusion Blow-Molding

### A: Polymerization

859 g (6 mol) of 1,4-cyclohexanedimethanol, 871 g (6 mol) of isosorbide, 1800 g (10.8 mol) of terephthalic acid, 1.5 g of Irganox 1010 (antioxidant) and 1.23 g of dibutyltin oxide (catalyst) are added to a 7.5 l reactor. To extract the residual oxygen from the isosorbide crystals, four vacuum-nitrogen cycles are performed once the temperature of the reaction medium is between 60 and 80° C. The reaction mixture is then heated to 275° C. (4° C./min) under 6.6 bar of pressure and with constant stirring (150 rpm). The degree of esterification is estimated from the amount of distillate collected. The pressure is then reduced to 0.7 mbar over 90 minutes following a logarithmic ramp and the temperature is brought to 285° C. These vacuum and temperature conditions were maintained until an increase in torque of 10 Nm relative to the initial torque was obtained. Finally, a polymer rod is cast via the bottom valve of the reactor, cooled to 15° C. in a heat-regulated water bath and chopped into granules of about 15 mg.

The resin thus obtained has a reduced viscosity in solution of 54.9 ml/g. 1H NMR analysis of the polyester shows that the final polyester contains 44 mol % of isosorbide relative to the diols. With regard to the thermal properties (measured at the second heating), the polymer has a glass transition temperature of 125° C.

The resin thus obtained has a reduced viscosity in solution of 54.9 ml/g. 1H NMR analysis of the polyester shows that the final polyester contains 44 mol % of isosorbide relative to the diols. With regard to the thermal properties (measured at the second heating), the polymer has a glass transition temperature of 125° C.

### B: Production of Hollow Articles by Parison Extrusion

The PITG granules obtained in polymerization step A are dried under vacuum at 110° C. in order to achieve residual moisture contents of less than 300 ppm; in this example, the water content of the granules is 230 ppm. The granules, kept in a dry atmosphere, are introduced into the hopper of the extruder.

The extrusion is carried out on a HESTA HV200 extrusion blow-molding machine, and the settings are assembled in table 1 below:

TABLE 1

| Name | Units | Values |
|---|---|---|
| Temperature of the plastic in the | ° C. | 250/250/260/ |
| melt state (extruder/die) | | 260/270/270 |
| Temperature of the mold | ° C. | 50 |
| Injection rate | rpm | 100 |
| Blowing time | sec | 7 |
| Control time | s | 1 |
| Permissible pressure drop | mbar | 5 |
| Cycle time | s | 15 |
| Production speed | Bottles/hour | 240 |

Using an annular die, a parison is continuously extruded. The mold closes around a parison, a blade cuts the parison at the top of the mold and the mold is transferred to a second work station.

At that time, a blow pin injects compressed air into the parison in order to press it against the walls of the mold. The molten material is kept under pressure and cooled against the walls. The mold is then transferred to the final work station where a knife trims off the surplus material and a leaktightness test is carried out while keeping the bottle under pressure. Finally, after opening the mold, the part is ejected and the mold returns to its initial position and closes around a new parison.

The bottle formed in this way has a homogeneous distribution of material, the volume thereof is 1 l and, after trimming, the weight of the part is 77 g. Moreover, it has good stability to chemical products.

1-7. (canceled)

8. A method for the production of a hollow article, comprising the step of using an amorphous thermoplastic polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
the (A)/[(A)+(B)] molar ratio being at least 0.32 and at most 0.90;
said polyester not containing any aliphatic non-cyclic diol units or comprising a molar amount of aliphatic non-cyclic diol units, relative to all the monomer units of the polyester, of less than 5%, and the reduced viscosity in solution (25° C.; phenol (50% m): ortho-dichlorobenzene (50% m); 5 g/l of polyester) of said polyester being greater than 50 ml/g.

9. The method according to claim 8, wherein the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

10. The method according to claim 8, wherein the 1,4:3,6-dianhydrohexitol (A) is isosorbide.

11. The method according to claim 8, wherein the polyester does not contain any aliphatic non-cyclic diol units, or comprises a molar amount of aliphatic non-cyclic diol units, relative to all the monomer units of the polyester, of less than 1%; preferably, the polyester does not contain any aliphatic non-cyclic diol units.

12. The method according to claim 8, wherein the production is carried out by extrusion blow-molding or injection molding.

13. The method according to claim 8, wherein the hollow article also comprises an additive such as an antioxidant or a dye.

14. A hollow article, comprising an amorphous thermoplastic polyester comprising:
at least one 1,4:3,6-dianhydrohexitol unit (A);
at least one alicyclic diol unit (B) other than the 1,4:3,6-dianhydrohexitol units (A);
at least one terephthalic acid unit (C);
the (A)/[(A)+(B)] molar ratio being at least 0.32 and at most 0.90;
said polyester not containing any aliphatic non-cyclic diol units or comprising a molar amount of aliphatic non-cyclic diol units, relative to all the monomer units of the polyester, of less than 5%, and the reduced viscosity in solution (25° C.; phenol (50% m): ortho-dichlorobenzene (50% m); 5 g/l of polyester) of said polyester being greater than 50 ml/g.

15. The hollow article according to claim 14, wherein the alicyclic diol (B) is a diol chosen from 1,4-cyclohexanedimethanol, 1,2-cyclohexanedimethanol, 1,3-cyclohexanedimethanol or a mixture of these diols, very preferentially 1,4-cyclohexanedimethanol.

16. The hollow article according to claim 14, wherein the 1,4:3,6-dianhydrohexitol (A) is isosorbide.

17. The hollow article according to claim 14, wherein the polyester does not contain any aliphatic non-cyclic diol units, or comprises a molar amount of aliphatic non-cyclic diol units, relative to all the monomer units of the polyester, of less than 1%; preferably, the polyester does not contain any aliphatic non-cyclic diol units.

18. The hollow article according to claim 14, wherein the hollow article also comprises an additive such as an antioxidant or a dye.
